(19) United States
(12) Patent Application Publication
(10) Pub. No.: US 2012/0163317 A1
(43) Pub. Date: Jun. 28, 2012

(54) APPARATUS AND SYSTEM OF PROVIDING WIRELESS LOCAL AREA NETWORK SERVICE FOR TRANSPORT MEANS

(75) Inventors: Heejung YU, Daejeon (KR); Hun Sik Kang, Daejeon (KR); Sok Kyu Lee, Daejeon (KR)

(73) Assignee: Electronics and Telecommunications Research Institute, Daejeon (KR)

(21) Appl. No.: 13/335,664

(22) Filed: Dec. 22, 2011

(30) Foreign Application Priority Data
Dec. 23, 2010 (KR) 10-2010-0133435

(51) Int. Cl. H04W 84/12; H04W 72/00

(52) U.S. Cl. 370/329; 370/338

(57) ABSTRACT

A wireless apparatus providing wireless LAN services for a transport means is provided. The wireless apparatus includes: a transceiver established to transmit or receive a frame; and a processor functionally connected to the transceiver, wherein the processor is established to generate and process the frame for providing the wireless LAN services, the transceiver includes a plurality of remote antennas, and the plurality of remote antennas are disposed to be spaced away from each other along a moving path of the transport means.

### CROSS-REFERENCE TO RELATED APPLICATIONS

This application claims the benefit of priority of Korean Patent Application No. 10-2010-0133435 filed on Dec. 23, 2010, all of which are incorporated by reference in their entirety herein.

### BACKGROUND OF THE INVENTION

1. Field of the Invention

The present invention relates to wireless communication, and more particularly, to an apparatus and a system of providing a wireless local area network service for a transport means.

2. Related Art

Recently, with the development of an information and communication technology, various wireless communication technologies have been developed. Among others, a WLAN is a technology of wirelessly accessing the Internet in home, business, or specific service providing areas by using mobile terminals such as a personal digital assistant (PDA), a lap top computer, a portable multimedia player (PMP), or the like, based on a wireless communication technology.

Institute of Electrical and Electronics Engineers (IEEE) 802, which is the organization that standardizes WLAN technology, established in February 1990, has provided many standards for communication technology.

At the beginning, the WLAN technology supported a rate of 1 to 2 Mbps by frequency hopping using 2.4 GHz frequency, spread spectrum, infrared communication, or the like, based on IEEE 802.11. Recently, the WLAN technology can support a rate at a maximum of 54 Mbps by using orthogonal frequency division multiplex (OFDM). In addition, IEEE 802.11 has practically used or developed standards of various technologies such as enhancement of quality for service (QoS), compatibility of access point protocol, security enhancement, radio resource measurement, wireless access vehicular environment, fast roaming, mesh network, interworking with external network, wireless network management, or the like.

Further, in order to overcome a limitation of communication rate considered to be a weakness in the WLAN, there is IEEE 802.11n as a technology standard recently established. IEEE 802.11n is to increase the rate and reliability of the network and expand the operation distance of the wireless network. More specifically, IEEE 802.11n supports high throughput (HT) having a data processing rate of a maximum of 540 Mbps and is also based on a multiple inputs and multiple outputs (MIMO) technology using multiple antennas at both ends of a transmitter and a receiver so as to minimize transmission errors and optimize a data rate. In addition, the standard may use a coding scheme transmitting several duplicated copies in order to increase data reliability and may also use the orthogonal frequency division multiplex (OFDM) so as to increase a rate.

In order to correspond to a demand for the WLAN service explosively increased and efficiently process high-capacity multimedia data, a study and a discussion for establishing IEEE 802.11 ac and IEEE 802.11 ad have been actively conducted. In order to implement the access of multi-users through the introduction of the MU-MIMO technology and obtain the high throughput, a study for data transmission through more spatial streams using the multiple antenna and the introduction and optimization of a smart antenna related technology in addition to beamforming have been conducted.

The IEEE 802.11 system has a limitation in supporting the mobility of the terminal by using the communication system developed in consideration of the communication environment in a limited space in an office or a home. However, a demand for the mobility support of the terminal has been increased due to the appearance of a plurality of mobile devices using the recent WLAN system. In particular, a need exists for a method of stably providing the WLAN service to a user within the transport means such as a train, an express bus, or the like.

### SUMMARY OF THE INVENTION

The present invention provides a method and an apparatus of stably providing WLAN services to users within a transport means such as a train, an express bus.

In an aspect, a wireless apparatus providing wireless LAN services for a transport means is provided. The wireless apparatus providing wireless LAN services for a transport means includes: a transceiver established to transmit or receive a frame; and a processor functionally connected to the transceiver, wherein the processor is established to generate and process the frame for providing the wireless LAN services, the transceiver includes a plurality of remote antennas, and the plurality of remote antennas are disposed to be spaced away from each other along a moving path of the transport means.

### BRIEF DESCRIPTION OF THE DRAWINGS

FIG. 1 is diagram schematically showing a configuration of an example of a wireless LAN system.

FIG. 2 is a diagram showing a structure of providing wireless communication services to a train having a plurality of antennas mounted at the outside thereof through a single AP having a plurality of remote antennas according to the exemplary embodiment of the present invention.

FIG. 3 is a diagram showing a connection structure of APs mounted on the inside and the outside of a train and multiple antennas for providing services according to the exemplary embodiment of the present invention.

FIG. 4 is a diagram showing an example of a method of managing remote antennas connected to APs at a trackside according to the exemplary embodiment of the present invention.

FIG. 5 is a diagram showing a condition in which handover is generated between the trackside APs including the remote antennas.

FIG. 6 is a block diagram showing a wireless apparatus implemented according to the exemplary embodiment of the present invention.

### DESCRIPTION OF EXEMPLARY EMBODIMENTS

Hereinafter, exemplary embodiments of the present invention will be described in detail with reference to the accompanying drawings.

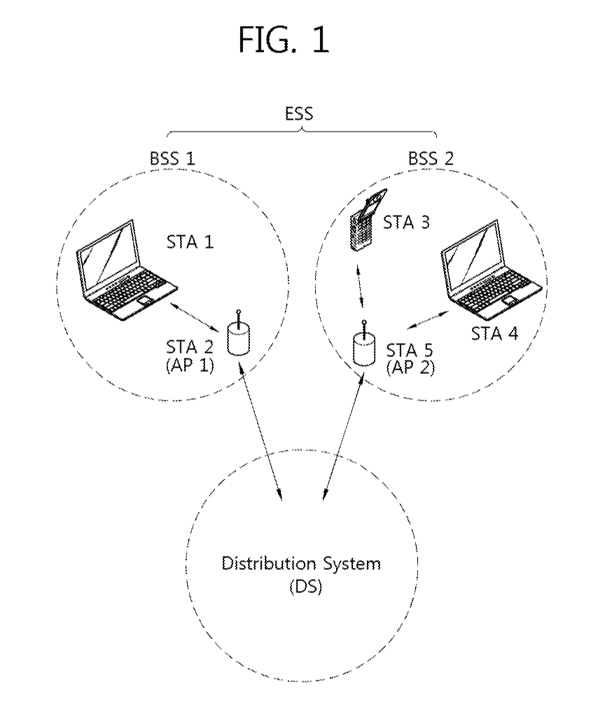

FIG. 1 is diagram schematically showing a configuration of an example of a wireless LAN system.

Referring to FIG. 1, a wireless LAN system includes more than one basic service set (BSS). The BSS is a set of STAs that are successfully synchronized and thus, can communicate with each other and does not include a concept indicating a specific region. The BSS may be divided into an infrastructure BSS and an independent BSS (IBSS). FIG. 1 shows the infrastructure BSS. The infrastructure BSS BSS1 and BSS2 includes more than one STA STA1, STA3, and STA4, an AP that is the STA providing a distribution service, and a distribution system (DS) connecting a plurality of APs AP1 and AP2. On the other hand, since the IBSS does not include the AP, all the STAs are configured of a mobile station and do not access the DS and thus, forms a self-contained network.

The STA includes a medium access control (MAC) according to IEEE 802.11 standard and includes both of the AP and non-AP station, in a broad sense, as any function medium including a physical layer interface for a wireless medium.

In a VHT wireless LAN system to which the exemplary embodiment of the present invention may be applied, the STA included in the BSS may coexist the VHT STA supporting the IEEE 802.11ac standard or an HT STA or a legacy STA (for example, non-HT STA supporting IEEE 802.11a/b/g standard) supporting the IEEE 802.11n.

Among the STAs, a mobile terminal operated by a user, which is Non-AP STAs STA1, STA3, STA4, STAG, STAT, and STAB, indicates the Non-AP STA when being simply referred to as STA. The Non-AP STA may be referred to as other names such as a terminal, a wireless transmit/receive unit (WTRU), a user equipment (UE), a mobile station (MS), a mobile terminal, a mobile subscriber unit, or the like.

Further, the APs AP1 and AP2 is a function entity providing the access to the DS via the wireless medium for the associated station (STA) connected thereto. In the infrastructure BSS including the AP, the communication between the non-AP STAs may be basically performed via the AP, but may be directly performed between the non-AP STAs when a direct link is established. The AP may be referred to as the access point but may also be referred to as a centralized controller, a base station (BS), a node-B base transceiver system (BTS), or a cite controller, or the like.

The plurality of infrastructure BSSs may be connected to each other through the distribution system (DS). The plurality of BSSs connected through the DS is referred to as an extended service set (ESS). The STAs included in the ESS may communicate with each other and the non-AP STA may move from a single BSS to another BSS while seamlessly communicating within the same ESS.

The DS is a mechanism that communicates the single AP with another AP. Therefore, the AP may transfer a frame for the STAs connected with the BSS managed by the AP or may transfer the frame when any one STA moves to another BSS or a frame to an external network such as a wired network, or the like. The DS may be not necessarily a network and the shape thereof does not have any limitation when the DS may provide a predetermined distribution service specified in IEEE 802.11. For example, the DS may be a wireless network such as a mesh network or may be a physical structure connecting the APs to each other.

For convenience of explanation, upon describing the exemplary embodiment of the present invention, a detailed example of the transport means describes a train. However, the exemplary embodiment of the present invention is not limited thereto but includes other transport means such as an express bus.

In the wireless LAN system according to the related art shown in FIG. 1, it is assumed that the STAs is in a semi-fixed state or has the mobility of the limited range. However, a spread of the mobile device supporting the mobility is generalized and a need to provide the wireless LAN service for the mobile device having mobility is increasingly increased. The exemplary embodiment of the present invention proposes a method and an apparatus of stably providing wireless LAN services to users within a transport means moving at high speed.

With the development of the transport means such as a high-speed train, or the like, a study for a network configuration for providing wireless Internet services for high-speed train passengers has been actively conducted. The method and apparatus of providing services according to the exemplary embodiment of the present invention may provide the good-quality wireless data communication services having the high transmission rate while configuring the network at low cost by using the wireless LAN technology using the unlicensed band. The method and apparatus of providing services use the multiple antenna technology used in the high-speed wireless LAN technology and may simultaneously solve the problem of the handover that may be the most important problem when using the wireless LAN.

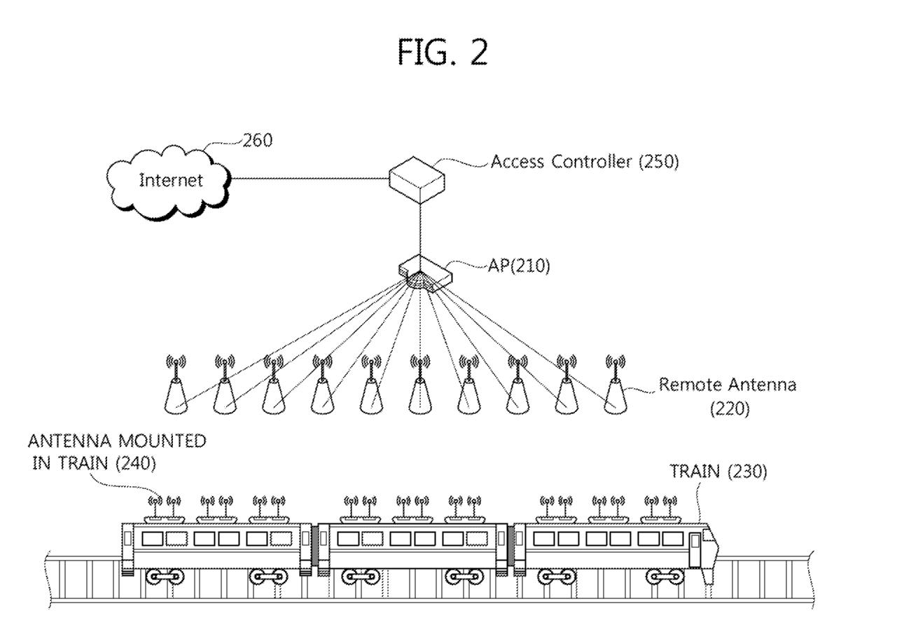

FIG. 2 is a diagram showing a structure of providing wireless communication services to a train having a plurality of antennas mounted at the outside thereof through a single AP having a plurality of remote antennas according to the embodiment of the present invention. The AP having the existing multiple antennas has a plurality of antennas mounted at the outside of the body thereof. However, in the exemplary embodiment of the present invention, the plurality of remote antennas 220 connected with the AP 210 in a wired form are disposed along a train track. That is, the single AP cell is configured along a long track. In this configuration, the remote antenna 220 is configured to a simple apparatus performing only a role of wirelessly transmitting or receiving the RF signal. Further, the plurality of antennas 240 are mounted at the outside of the train 230 and are connected with the AP 210 so as to provide the services to passengers in the train. The AP 210 may be connected with an Internet network 260 via an access controller 250.

A multiple input multiple output (MIMO) channel spatially widely distributed may be provided between the AP 210 and the train 230. Generally, it has been known that the MIMO channel capacity is greatly degraded in a line-of-sight channel environment, but when the distance between the remote antennas 220 is sufficiently spaced as in the configuration of the exemplary embodiment of present invention, the reduction in MIMO channel capacity due to the line-of-sight channel environment may be reduced.

Referring to the configuration of the trackside AP 210, all the portions including the AP function unlike the existing APs are included in all the APs, but the multiple antennas are connected to the outside unlike the related art so as to be disposed around the train track at a predetermined distance. The plurality of antennas 220 at a position geographically spaced away from one another is mounted at a single AP 210. Therefore, a service region covering the single AP 210 is considerably expanded. Considering the train that is a service target, even though the plurality of antennas 220 is mounted, only some remote antennas close to the current position of the train are used to transmit a signal. Further, the remaining remote antennas are in a standby state. Further, the plurality of antennas 220 are mounted at the outside of the train 240 to communicate with the trackside AP 210. The antenna 240 at the outside of the train may be mounted while maintaining a sufficient interval within a possible range so as to have low correlation with one another.

Even in the case of the MIMO channel having the same number of transmitting and receiving antennas, the line-of-sight (LOS) channel is secured and when the interval between the antennas as in the related art is small, the rank of the channel matrix is small or the condition number is large, such that the MIMO channel capacity is considerably degraded. However, even in the case of the channel environment in which the line-of-sight channel is secured, it is known that the loss of the MIMO channel capacity may be reduced when only the antenna interval is sufficient. (Reference Document: I. Sarris, A. R. Nix, “A line-of-sight optimized MIMO architecture for outdoor environments,” in proc. IEEE VTC 2008 Fall, September 2006.) Therefore, the structure according to the exemplary embodiment of the present invention has many advantages in view of the MIMO channel capacity.

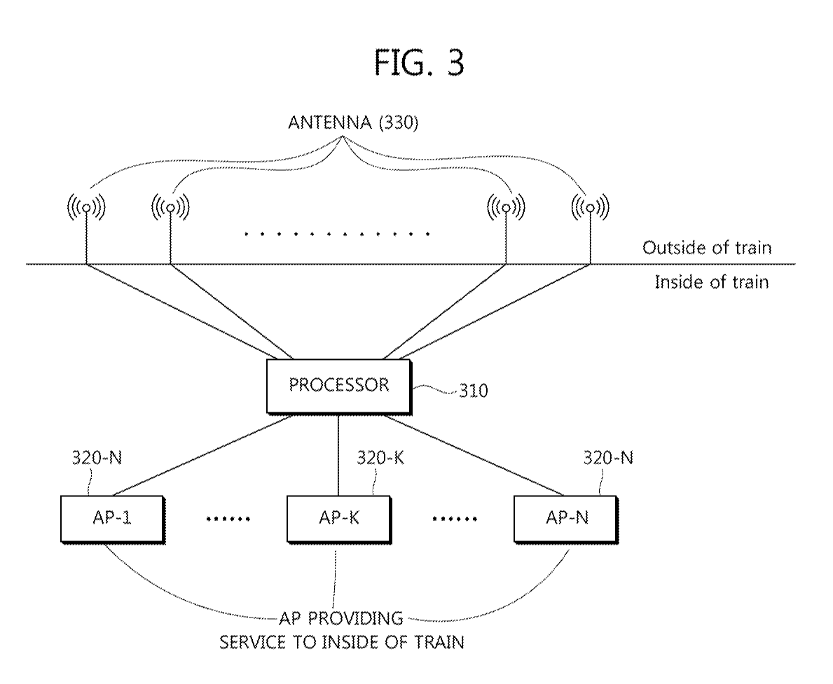

FIG. 3 is a diagram showing a connection structure of an AP mounted on the inside and the outside of a train and multiple antennas for providing services according to the exemplary embodiment of the present invention.

As shown in FIG. 3, the signal is received and transmitted from and to the trackside AP (not shown) by mounting an antenna 330 at the outside of the train and APs AP-1, . . . , AP-K, . . . , AP-N to be used in the inside of the train may be mounted. Further, the connection structure may include a process block 310 performing a process such as a bridge converting and connecting the external signal and the internal signal. In this case, in order to remove the communication interference between the inside and the outside of the train, the trackside APs (the APs (not shown), the APs AP-1, . . . , AP-K, . . . , AP-N for the internal service) may use different frequencies.

In the structure of the inside of the train, an external-internal bridge process 310 connected with the external antennas converts the signals of the external AP (the trackside AP, corresponding to 210 of FIG. 2) into the signals of APs 320-1, 320-K, 320-N, or the like, for the internal service and transmits the converted signals to the internal APs 320-1, 320-K, 320-N, or the like, such that the internal APs 320-1, 320-K, 320-N, or the like, can communicate with the terminal of the passengers. The internal APs 320-1, 320-K, 320-N, or the like, may exist in each passenger car and the number thereof may be controlled according to conditions, such as a signal coverage, and traffic demand for each passenger car, or the like. In this case, the frequency used at the trackside APs is not used in the APs 320-1, 320-K, 320-N, or the like, for the internal service, such that the propagation interference may be removed. In addition, the internal APs 320-1, 320-K, 320-N, or the like, may be alternately used by using different frequency channels in consideration of the structure of the train. When more than two channels are differently used for each passenger car of the train in consideration of the service coverage of the AP, the interference effect may be sufficiently reduced.

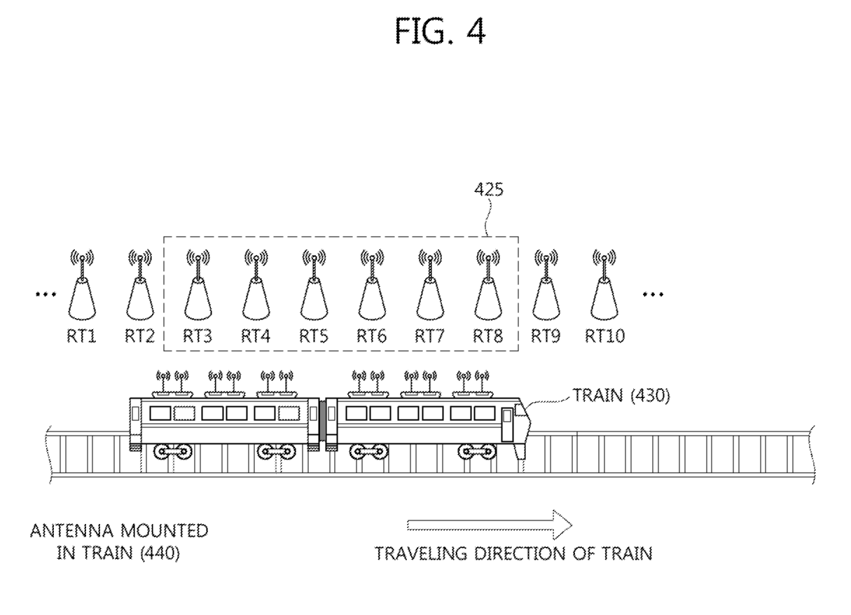

FIG. 4 is a diagram showing an example of a method for managing a remote antenna connected to an AP at a trackside according to the exemplary embodiment of the present invention.

In the example of FIG. 4, a set 425 of remote antennas RT3 to RT8 in the inside of a dotted line, which is the remote antenna facing a current train 430, is used to configure the MIMO channel between the trackside APs (not shown) and the train 430 and therefore, the group thereof may be defined by an active set. The remaining remote antennas RT1, RT2, RT9, and RT10 other than the remote antennas belonging to the active set are not used for signal transmission and/or transmission. The group thereof is referred to as an inactive set. However, since the current AP knows the traveling direction of the train, the remote antenna RT9 is in a candidate in which the inactive set is switched to the active set, that is, an active candidate set and the remote antenna RT3 is in a candidate in which the active set is switched to the inactive set, that is, the inactive candidate set. According to the traveling direction of the train, when the intensity of the received signal of the inactive candidate set RT3 is smaller than the intensity of the received signal of the remote antenna RT9 of the active candidate set, the remote antenna RT3 is switched to the active set and the remote antenna RT9 is switched to the active set. The above-mentioned process has a type in which the AP at the corresponding trackside changes only the used antenna and therefore, no communication process is changed. Therefore, even though the train moves, the service may be promptly provided without performing the complicated handover procedure. When the overall network according to the exemplary embodiment of the present invention is configured, the communication service may be seamlessly provided while changing the remote antenna used to transmit and receive the signals according to the movement of the train.

Hereinafter, the group of the remote antennas receiving, as the received power, the signal transmitting from the train around the position of the current train is defined by the active set. Through the active set, the communication may be performed. Further, the group of the remaining remote antennas other than the active set is defined by the inactive set. The group of the antennas in which the signal received from the train at the end portion based on the traveling direction of the train among the active sets is gradually weak is defined by the inactive candidate set. On the other hand, the group of the antennas in which the magnitude in the signal received from the train in the traveling direction of the train among the antennas in the inactive set is gradually large is defined by the active candidate set.

Therefore, when the magnitude in the signal received from the antenna belonging to the inactive candidate set is smaller than the magnitude in the signal received in the antenna belonging to the active candidate set, the remote antenna of the inactive candidate set is included in the inactive set and the remote antenna of the active candidate set is included in the active set. Thereby, even though the train moves, the remote antennas of the active set continue to move along the train, such that the communication may be continuously performed when the level of the signal is constantly maintained. Since the movement of the train is supported using only the selection of the remote antenna, a process similar to the handover may be simply performed without changing the communication protocol. Further, the complexity of the system may also be automatically controlled according to the overall traffic demand by controlling the number of antennas belonging to the active set.

However, when only the above-mentioned remote antenna management is used, only the single AP should configure the overall railroad network. Therefore, the AP having the plurality of remote antennas needs to be mounted in plural. In this case, the true handover needs to be performed in the trackside APs and between the trackside APs.

Since the wireless LAN does not support a soft-handover, the handover process in the wireless LAN system has a hard-handover form in which the WLAN disconnects with the previous AP and connects with a new AP. Therefore, in the case of the high-speed train, the delay due to the handover may be problematic. Therefore, the network may be designed so that the hard-handover frequency may be reduced as maximally as possible by using the AP having the proposed remote antenna form and the hard-handover is performed in the low-speed traveling area such as a flag station, a curved railroad, or the like.

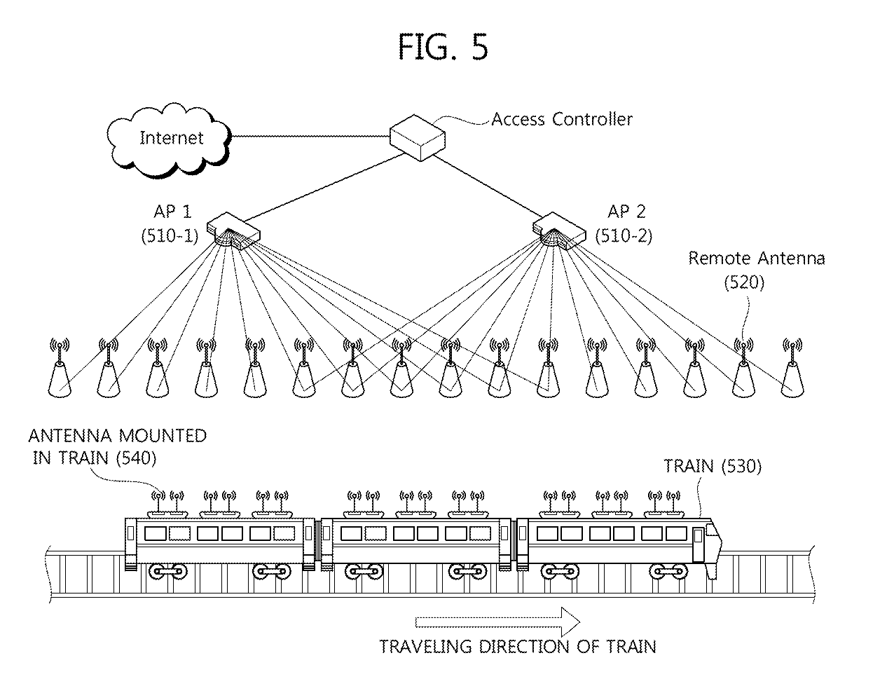

FIG. 5 is a diagram showing a condition in which handover is generated between the trackside APs including the remote antennas.

It is impossible for the overall track to provide services using the single AP and therefore, the plurality of trackside APs may be configured as shown in FIG. 2. When the service is provided through the plurality of trackside APs, the handover is performed between the trackside APs. For example, the flag station or the area (e.g. an area in which the train moves slowly due to a geographical factor such as a curved period, or the like, or a factor due to the surrounding facilities) in which the train moves slowly may be considered to be the candidate. The remote antennas may be connected with each other similar to two trackside APs, that is, an AP1 510-1 and an AP2 510-2 in the area in which the handover is performed. Therefore, the signal transmitted from the train may be simultaneously received from the AP1 510-1 and the AP2 510-2 while the train passes through the area. In this case, when the magnitude in the signal received from the AP2 510-2 is above some degree, the handover from the AP1 510-1 to the AP2 510-2 is performed in the access controller. As described above, since the handover is performed in the spatially wide region, the time delay limitation for the handover may be more reduced than before.

When the handover is performed in the area in which the service areas of two trackside APs 510-1 and 510-2 overlaps with each other, the antennas in the area are connected with both trackside APs 510-1 and 510-2 as shown in FIG. 5. Therefore, when the train 530 enters the handover area, the train may be connected to the two APs 510-1 and 510-2.

However, since the access controller managing the handover previously knows the traveling direction of the train, the access controller performs the hard-handover process that disconnects with the existing APs (AP1) 510-1 and reconnects with the new AP (AP2) 510-2. To this end, the AP1 510-1 informs the access control of the magnitude of the signal of the remote antenna corresponding to the active set and the AP2 510-2 also reports the magnitude of the signal received from the remote antenna of the active set or the active candidate set to the access controller.

In this case, the access controller determines whether the handover is performed through the information on the magnitude in the signal received from the AP1 510-1 and AP2 510-2 and may issue the command of the access stop to the AP1 510-1 and access the train in the AP2 510-2.

The handover timing may be differently set according to the conditions such as the velocity of the train, the distance of the cell overlapping area (a area in which the remote antennas are connected to two APs), or the like. For example, when the handover is performed in the flag station, after the train completely enters the cell overlapping area, it is enough as the handover is performed in the condition in which the magnitude in the signal of the AP2 510-2 is equal to the magnitude in the signal of the AP1 510-1. However, when the train enters a high-speed area and the cell overlapping area is short, in the active set of the AP1 510-1, even though the intensity of the received signal of the AP2 510-2 is smaller than that of the AP1 510-1 since the train partially enters the cell overlapping area, the handover is performed to consider the delay of the handover when the intensity is above some degree. However, when the cell overlapping area is sufficiently long even in the area in which the velocity of the train is rapid, there is no problem in performing the handover even after the train completely enters the cell overlapping area in the active set of the AP1. The above establishing may be sufficiently considered during the process of building the network.

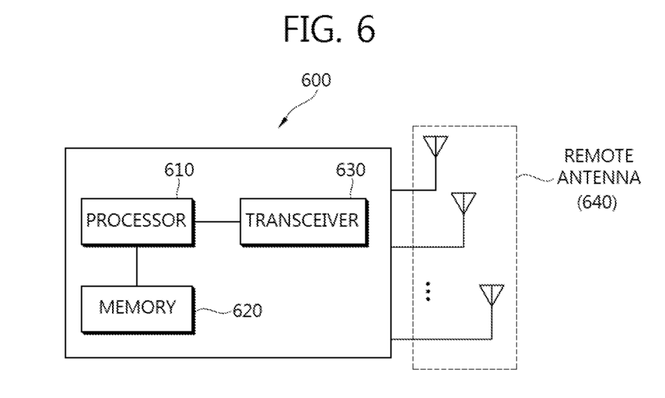

FIG. 6 is a block diagram showing a wireless apparatus implemented according to the exemplary embodiment of the present invention. The wireless AP may be the AP for providing the service in the trackside AP or the transport means. A wireless apparatus 600 includes a processor 610, a memory 620, and a transceiver 630. A transceiver 630 may have a plurality of network interface card (NICs).

The transceiver is established to transmit and/or receive the frame through the plurality of remote antennas 640. The plurality of remote antennas 640 are disposed along the moving path of the transport means that is an object of providing services. The plurality of remote antennas 640 may be connected with the wireless apparatus in a wired form. For example, when intending to provide the service to the train, the plurality of remote antennas may be disposed along the trackside that is the moving path of the train. The plurality of remote antennas 640 may be disposed while being adjusted to have the low correlation with one another.

The process 610 is functionally connected with the transceiver 630 to implement the method for providing services proposed according to the exemplary embodiment of the present invention. The processor 610 generates a control frame, a management frame, and a data frame for providing the wireless LAN service and is established to transmit the generated frame through the plurality of remote antennas via the transceiver 630. The processor 610 and the transceiver 630 may implement the physical layer of IEEE 802.11 and the MAC layer. The processor 610 and/or the transceiver 630 may include an application-specific integrated circuit (ASIC), other chip sets, a logical circuit and/or a data processing device. The memory 620 may include a read-only memory (ROM), a random access memory (RAM), a flash memory, a memory card, a storage medium and/or other storage devices. When the exemplary embodiments of the present invention are implemented by software, the above-mentioned methods may be implemented by a module (process, function, or the like) performing the above-mentioned functions. The module is stored in the memory 620 and may be executed by the processor 610. The memory 620 may be mounted in or out the processor 610 and may be connected to the processor 610 by well-known various units.

As set forth above, the exemplary embodiments of the present invention can provide the large-capacity wireless data services using the wireless LAN (IEEE 802.11n or IEEE 802.11ac system, or the like, using the multiple antenna) using the unauthorized band to the moving users.

The exemplary embodiments of the present invention can solve the problem of the degradation in the MIMO channel capacity due to the line-of-sight channel environment and the problem of the time delay due to the handover by reducing the frequency of the handover.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

What is claimed is:

1. A wireless apparatus providing wireless LAN services for a transport means, comprising:
a transceiver established to transmit or receive a frame; and
a processor functionally connected to the transceiver,
wherein the processor is established to generate and process the frame for providing the wireless LAN services,
the transceiver includes a plurality of remote antennas, and
the plurality of remote antennas are disposed to be spaced away from each other along a moving path of the transport means.

2. The wireless apparatus of claim 1, wherein the plurality of remote antennas are connected with the wireless apparatus in a wired form.

3. The wireless apparatus of claim 1, wherein the plurality of remote antennas are disposed so as to be adjusted to have low correlation with one another.

4. The wireless apparatus of claim 1, wherein the transceiver is established so as to transmit a frame or a data frame generated in the processor needed to provide the wireless LAN service for the transport means to the transport means through a first remote antenna adjacent to the transport means among the plurality of remote antennas.

5. A system of providing wireless LAN service for a transport means, comprising:
a plurality of access points (APs) providing the wireless LAN services to the transport means; and
an access controller controlling a connection between the transport means and the plurality of APs,
wherein each of the plurality of APs includes:
a transceiver established to transmit or receive a frame; and
a processor functionally connected to the transceiver,
wherein the processor is established to generate and process the frame for providing the wireless LAN services,
the transceiver includes a plurality of remote antennas, and
the plurality of remote antennas are disposed to be spaced away from each other along a moving path of the transport means.

6. The system of claim 5, wherein each of the plurality of APs performs provision of the wireless LAN service for some of the moving path of the transport means, and
the plurality of remote antennas of each of the plurality of APs are disposed so that handover allowing the transport means to switch a connection object from any one of the plurality of APs to another AP is performed in a stop area or a low-speed moving area of the transport means.

7. The system of claim 5, wherein each of the plurality of APs uses a channel of different frequency bands.

8. The system of claim 5, wherein a process of each of the plurality of APs is established to transmit and report information on a magnitude in a signal in communication with the transport means changed according to the movement of the transport means to the access controller.

9. The system of claim 8, wherein the access controller is established so as to determine any one of the plurality of APs providing the service to the transport means based on the information on the magnitude in the signal received from the plurality of APs.
